(19) United States
(12) Patent Application Publication
(10) Pub. No.: US 2010/0042580 A1
(43) Pub. Date: Feb. 18, 2010

(54) Method of for a Host to Access an Object Stored in a Multimedia Device Supported by MTP

(76) Inventors: Chih-Hung Cheng, Hsin-Chu City (TW); Jung-Chih Liu, Taipei County (TW); Xinping Qian, Hefei City (CN); Jian Zhang, Hefei City (CN); Junsong Ke, ShenZhen (CN)

Correspondence Address: NORTH AMERICA INTELLECTUAL PROPERTY CORPORATION, P.O. BOX 506, MERRIFIELD, VA, 22116, US

(21) Appl. No.: 12/191,316

(22) Filed: Aug. 14, 2008

(51) Int. Cl. G06F 17/30

(52) U.S. Cl. 707/1; 707/E17.009

(57) ABSTRACT

An object table is provided between a file system interface of a host and a multimedia device so that the host is capable of accessing objects stored in the multimedia device regardless of incompatibility between file formats respectively used in the file system and the multimedia device. At least one index of the stored object is stored in the object table. A file accessing architecture is constructed in the object table, where the file accessing architecture has at least one API recognizable for the file system interface. Therefore, the host is capable of accessing the objects stored in the multimedia device though the file system interface and the constructed file accessing architecture.

### BACKGROUND OF THE INVENTION

1. Field of the Invention

The present invention relates to a method of for a host to access an abject, and for a host to access an object stored in a multimedia device supported by Media Transfer Protocol (MTP).

2. Description of the Prior Art

On conventional multimedia devices, file systems are always installed so that a user of the multimedia device may access files stored in the multimedia devices with appropriate file system interfaces. File Allocation Table (FAT), which is a primary file system based on a folder tree structure, is used to be popular for multimedia devices. While a user accesses a multimedia device installed with FAT, FAT provides the user with a folder tree structure for listing files stored in the multimedia device. Therefore, while the user would like to access any files stored in the multimedia device, the folder tree structure is displayed on the user interface, which is supported by the file system interface, in a hierarchical manner so that the user may quickly find and access required files.

For implementing the folder tree structure, FAT provides and displays references, such as addresses, of the stored files of the multimedia device as members of the folder tree structure. While FAT calls the stored files by addresses, physical block addresses of the stored files in the multimedia device are transformed into logical block addresses, which are then used by FAT to reference the stored files on the folder tree structure. While the user would like to access a certain file in the multimedia device through the user interface, FAT transforms a logical block address of the file into a physical block address of said file with certain kind of address-mapping mechanism and then references said file with the physical block address. However, it is not a rigid way in referencing the stored files with logical block addresses since the address-mapping mechanism used between a logical block address and a corresponding physical block address takes huge and complex calculations, which are innate defects in calling files by references.

Media Transfer Protocol (MTP), which is a protocol for transferring multimedia files, such as image files and music files, is specifically designed for manipulating files stored in a multimedia device as objects. With the aid of MTP, multimedia files stored in different multimedia devices are transferred as objects. Note that a host connecting to a multimedia device using MTP is called an MTP initiator whereas the multimedia device itself is called an MTP responder. MTP allows MTP initiators to identify specific capabilities of MTP responders with respect to file formats and functionality so that a MTP initiator may quickly perceive files stored in the MTP responder without using the folder tree structure.

However, while a user of a host, which is merely capable of recognizing a file system, for example, FAT, other than MTP, tends to access files stored in a MTP responder, a user interface of the host cannot display file-related information for the user since the file system interface supporting the user interface dose not support MTP. Modifying the file system interface to cooperate with MTP may be a feasible but effort-taking solution.

### SUMMARY OF THE INVENTION

The claimed invention discloses a method for a host to access an object stored in a multimedia device supported by Media Transfer Protocol (MTP). The method comprises providing an object table between a file system interface of the host and the multimedia device; storing at least one index of the object into the object table; and constructing a file accessing architecture in the object table based on the at least one index. The file accessing architecture has at least one file accessing API (Application Programming Interface) recognizable for the file system interface. The host accesses the object stored in the multimedia device through the file system interface and the file accessing architecture like accessing a file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram for explaining the method for a host to access an object stored in a multimedia device supported by MTP according to the present invention.

FIG. 2 illustrates a flowchart of the method for a host to access an object stored in a multimedia device supported by MTP according to the present invention.

### DETAILED DESCRIPTION

For having a host, which does not support MTP, be able to cooperate with a multimedia device installed with MTP, i.e., a MTP responder, a method for a host to access an object stored in a multimedia device supported by MTP is provided. An object table is provided in the present invention between a file system, which may be tree-structure-based or of any other file accessing architecture on a host, and a multimedia device using MTP. With the aid of the disclosed method of the present invention, the host using a file system interface is allowed to access a required file indicated by accessing a corresponding object stored a multimedia device installed with MTP, i.e., a MTP responder, without modifying its file system interface. The user interface supported by the file system interface may be capable of listing stored objects in the multimedia device with a corresponding file accessing architecture, which is constructed according to indexes stored in the object table. The file accessing structure is recognizable for a folder tree structure or any other structure, which is not substantially supported by MTP and is recognizable for a conventional file system format, such as FAT, since the object table is supported by the constructed file accessing architecture having at least one application programming interface (API) similar with at least one API of the file system format, i.e., FAT.

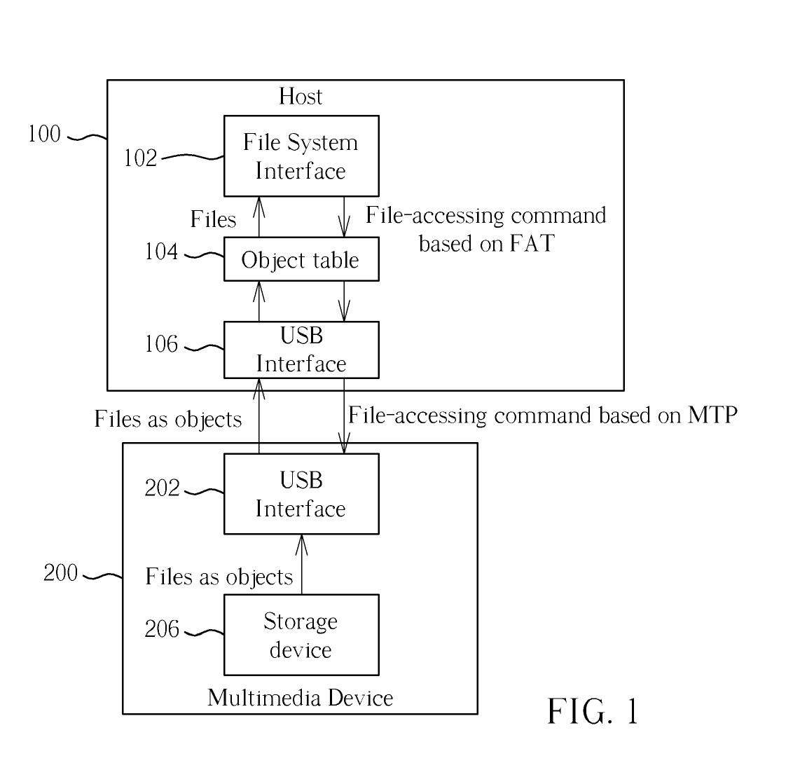

Please refer to FIG. 1, which is a schematic block diagram for explaining the method for a host to access an object stored in a multimedia device supported by MTP according to the present invention. As shown in FIG. 1, a host 100 includes a file system interface 102, an object table 104, and a first USB (Universal Serial Bus) interface 106. A multimedia device 200 may include a second USB interface 202 and a storage device 206. The host 100 is installed with the file system interface 102, whereas the multimedia device 200 is installed with MTP. The file system interface 102 is assumed to apply FAT hereafter for clear disclosures, however, in other embodiments of the present invention, the file system interface 102 may still apply other types of file system formats other than FAT. The file system used in conjunction with the file system interface may be tree-structure-based or of any other file accessing architectures. Therefore, the FAT-based host 100 may not be capable of recognizing objects stored in the multimedia device 200 since MTP is not compatible with a FAT-based file structure. The first USB interface 106 supported by the file system interface 102 is directly manipulated by a user of the host 100. The first USB interface 106 and the second USB interface 202 work together for physical connections between the host 100 and the multimedia device 200 since MTP is supported by USB. The object table 104 is responsible for storing or handling mappings between file-accessing commands based on MTP and file-accessing commands based on the file system interface 102 between the host 100 and the multimedia device 200, where a file accessing architecture built in the object table 104 is constructed based on stored at least one index in the object table 104. Objects for indicating multimedia files are deposited in the storage device 206 of the multimedia device 200. Note that FIG. 1 shows a concept of layers so that the disclosure related to FIG. 1 is based on software/protocol implementations so that the file accessing architecture constructed in the object table 104 is not illustrated. However, other implementations, such as hardware/physical implementations, are also applicable. As can be inducted from the above descriptions, the host 100 is able to access objects stored in the multimedia device 200 though the file system interface 102 and the constructed file accessing architecture like accessing a file, i.e., simulating a procedure of accessing a file.

The disclosed method of the present invention is explained as follows. One feature of the method of the present invention lies in the object table 104 having the constructed file accessing architecture in the present invention. Briefly, the object table 104 acts as a bridge between the host 100 using file system accessing APIs (Application Programming Interface), which may be tree-structure-based in the file accessing architecture, and the multimedia device 200 using MTP, which is object-based (or object-oriented), since the host 100 can not directly use the file system accessing API to access the multimedia device 200. Though the file system accessing API in this embodiment is tree-structure-based, the file system could also be based on any other file accessing architectures in embodiments of the present invention. The object table 104 may be generated partially in advance before the user of the host 100 tends to access stored objects for indicating files in the storage device 206 through the file system interface 102 as an initialization. At least one index of an object in the storage device 206 may be stored in the object table 104 for constructing the file accessing architecture, where the indexes may include a filename, an editor, a modified time, etc. Therefore, the object table 104 having the constructed file accessing architecture is capable of providing file-accessing APIs simulating typical file system accessing APIs to the file system interface 102, where file accessing commands of the file system accessing APIs may include File Open, File Close, File Read, File Write, File Seek, etc, and in other words, an object in the multimedia device 200 may be opened, closed, read, written, and seek, like a file. Moreover, in a view of the file system interface 102, the object table 104 may operate like a FAT file system having a folder tree structure. Note that the object table 104 is capable of mapping file-accessing commands to the typical file system accessing APIs, where the mapped file-accessing commands include File Open, File Close, File Read, File Write, File Seek, etc.

While a user of the host 100 intends to access objects stored in the storage device 206 like accessing a file, i.e., in the multimedia device 200, through the file system interface 102, the object table 104 provides a folder tree structure with indexes of the objects stored in the multimedia device 200 so that the user may pick up required objects through manipulations on the first USB interface 106 supported by the file system interface 102. The file system interface 102 then issues file-accessing commands to the object table 104 according to required objects of the user. In the provided file system accessing APIs, there may be file names or file reference paths as attributes; however, the multimedia device 200 may be merely able to recognize the file-accessing commands based on MTP other than commands of the file system accessing APIs. Therefore, the file system interface 102 issues file-accessing commands, which are corresponding to the folder tree structure and then transformed into file accessing commands based on MTP according to the stored mappings in the object table 104, and are sent to the USB interface 202, which then retrieves required objects in the storage device 206 for the object table 104 according to the MTP-based file-accessing commands. Note that at this time, in a view of the object table 104 towards the storage device 206 (or the multimedia device 200), the objects stored in the storage device 206 are manipulated by the file system interface 102 through the object table 104. Moreover, one object stored in the storage device 206 may be referred by at least one index stored in the object table 104 according embodiments of the present invention.

With the aid of the method of the present invention, the file system interface unsupported by MTP, i.e., the file system interface 102 of the host 100, is not required to be modified for fitting formats of MTP since mappings are fulfilled by the object table 104. Moreover, in a view of the user of the host 100, objects stored in the multimedia device 200 seem to be operated like files under a file system, such as FAT, since the object table 104 provides a folder tree structure for listing the objects on the file system interface 102 and corresponding file accessing commands to the file system interface 102. Last, objects stored in the multimedia device 200 can be manipulated with a user of the host 100 through the USB interface 106 like files since the object table 104 fits operations of the multimedia device 200, and since operations of MTP are object-oriented. Note that operations based on objects are much simpler than those based on references to files, therefore, the object table 104 also enhances object managements like file managements between the host 100 and the multimedia device 200.

In summary, the method for a host to access an object stored in a multimedia device supported by MTP includes steps as follows:
Step 302: Provide an object table between a file system interface of the host and the multimedia device;
Step 304: Store at least one index of the object into the object table; and
Store 306: Construct a file accessing architecture in the object table based on the at least one index.

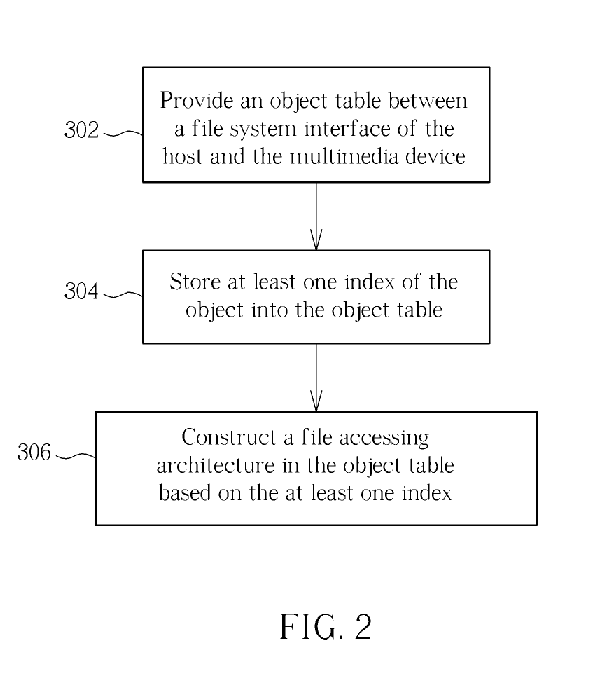

Though a folder tree structure is illustrated in this embodiment, any other structure may also be applied in embodiments of the present invention. The above-listed steps are illustrated in FIG. 2. Detailed descriptions about the above-listed steps have been disclosed above so that the detailed descriptions are not described further for brevity. The multimedia device 200 mentioned above may be a MP3 player or any other multimedia device using MTP. The host 100 may be a DVD player, a television, a personal computer or any apparatus installed with a file system.

Those skilled in the art will readily observe that numerous modifications and alterations of the device and method may be made while retaining the teachings of the invention.

What is claimed is:

1. A method for a host to access an object stored in a multimedia device supported by Media Transfer Protocol (MTP), comprising:
providing an object table between a file system interface of the host and the multimedia device;
storing at least one index of the object into the object table; and
constructing a file accessing architecture in the object table based on the at least one index;
wherein the file accessing architecture has at least one file accessing API (Application Programming Interface) recognizable for the file system interface; and
wherein the host accesses the object stored in the multimedia device through the file system interface and the file accessing architecture like accessing a file.

2. The method of claim 1 wherein the at least one file accessing API has at least one file-accessing command.

3. The method of claim 2 wherein the at least one file-accessing command is initiated from the file system interface for accessing the object stored in the multimedia device.

4. The method of claim 3 wherein a mapping between at least one candidate file-accessing command based on MTP and at least one candidate file-accessing command from the file system interface is stored in the object table.

5. The method of claim 4 further comprising:
the object table transforming the at least one file-accessing command initiated from the file system interface into a corresponding MTP-based file-accessing command according to the stored mapping in the object table.

6. The method of claim 1 wherein storing the at least one index of the object into the object table comprises:
storing a filename corresponding to the object into the object table.

7. The method of claim 1 wherein storing the at least one index of the object into the object table comprises:
storing an editor corresponding to the object into the object table.

8. The method of claim 1 wherein storing the at least one index of the object into the object table comprises:
storing a modified time corresponding to the object into the object table.

9. The method of claim 1 wherein the at least one file accessing API provides a file-accessing command for opening the object stored in the multimedia device like opening the file.

10. The method of claim 1 wherein the at least one file accessing API provides a file-accessing command for closing the object stored in the multimedia device like closing the file.

11. The method of claim 1 wherein the at least one file accessing API provides a file-accessing command for reading the object stored in the multimedia device like reading the file.

12. The method of claim 1 wherein the at least one file accessing API provides a file-accessing command for writing data into the object stored in the multimedia device like writing data into the file.

13. The method of claim 1 wherein the at least one file accessing API provides a file-accessing command for seeking the object stored in the multimedia device like seeking the file.

14. The method of claim 1 wherein the file accessing architecture uses a folder-tree-structure-based file system format.

15. The method of claim 1 wherein a file system format of the file accessing architecture is File Allocation Table (FAT).

16. The method of claim 1 wherein the multimedia device is a MP3 player.

17. The method of claim 1 wherein the host is a DVD player, a television, or a personal computer.

18. The method of claim 1 wherein the file system interface corresponds to a tree-structure-based file system.
